(19) United States
(12) Patent Application Publication
(10) Pub. No.: US 2020/0094588 A1
(43) Pub. Date: Mar. 26, 2020

(54) INKJET IMAGE FORMATION APPARATUS

(71) Applicant: Oki Data Corporation, Tokyo (JP)

(72) Inventor: Masaru HIRATA, Tokyo (JP)

(73) Assignee: Oki Data Corporation, Tokyo (JP)

(21) Appl. No.: 16/546,234

(22) Filed: Aug. 20, 2019

(30) Foreign Application Priority Data
Sep. 21, 2018 (JP) 2018-176851

(51) Int. Cl. B41J 11/00; B65H 7/14

(52) U.S. Cl. CPC B41J 11/009; B65H 7/14; B41J 11/0095; B41J 11/003

(57) ABSTRACT

An aspect of one or more embodiment may be an inkjet image formation apparatus that may include: a head drive processor that drives a recording head to eject ink; a conveyance processor that drives a conveyance member to convey a recording medium; a carriage drive processor that drives a carriage with the recording head to move in a main scanning direction; a medium detector movable in the main scanning direction and configured to detect the recording medium on a platen; and a medium detection processor that obtains an output of the medium detector that detects plural points on the recording medium, and identify a type of the recording medium based on the obtained output of the medium detector at the plural points.

### CROSS REFERENCE TO RELATED APPLICATIONS

This application claims priority based on 35 USC 119 from prior Japanese Patent Application No. 2018-176851 filed on Sep. 21, 2018, the entire contents of which are incorporated herein by reference.

### BACKGROUND

The disclosure relates to an inkjet image formation apparatus.

An inkjet image formation apparatus, such as an inkjet printer, copier, facsimile, multi-function printer or peripheral (“MFP”) or the like, includes a carriage configured to move along a rail; recording heads mounted on the carriage and configured to eject inks of respective colors to attach the inks on a recording medium being conveyed, so as to form (print) a color image of letters, pictures, and the like on the recording medium.

In a related art, an inkjet printer is known which identifies a type of a recording medium based on an output of a medium detector such as an optical sensor or the like, and executes printing under a setting suitable for properties of the identified type of the recording medium.

In the inkjet printer, a light emitter in a medium guide part emits light to the recording medium, a light receiver or a light detector receives light reflected on the recording medium, and a controller identifies a type of the recording medium based on the sensor output of the light receiver, that is, the sensor output of the medium detector, and sets a print setting suitable for the identified type of the medium (see for example, Patent Document 1).

Patent Document 1: Japanese Patent Application Laid-Open No. 2016-215590

### SUMMARY

However, the inkjet printer of the related art may be unable to appropriately identify a type of a medium and thus unable to set an appropriate print setting suitable for the medium in a case where a retroreflective medium, for example, used for traffic signs or the like, is used as the recording medium, because the retroreflective medium has a structural characteristics that do not uniformly reflect the light.

For example, in a case where a normal recording medium such as a paper sheet, a resin film, or the like is used, the light emitted from the light emitter to the recording medium is reflected by specular reflection or diffuse reflection, and the reflected light of the specular reflection or the diffuse reflection is received by the light receiver.

In contrast, the retroreflective medium has a structure which, for example, includes a base layer and an intermediate layer on the base layer, wherein the intermediate layer includes a support layer and a reflective layer wherein the reflective layer includes a prismatic layer and an air layer. Thus, in a case where the retroreflective medium is used as a recording medium, the light emitted from the light emitter of the medium detector to the recording medium is reflected on the reflective layer of the retroreflective medium by a retroreflective reflection, and thus the reflected light returns to the light emitter. Therefore, the light receiver does not receive or scarcely receives the reflected light, and thus the controller cannot obtain the sensor output of the medium detector at an appropriate amount and cannot appropriately identify the type of the recording medium.

Therefore, in the case where the recording medium is a retroreflective medium, the printer cannot execute printing under settings suitable for the characteristics of the recording medium.

An object of an embodiment of the disclosure is to provide an inkjet image formation apparatus that can appropriately identify a type of a recording medium based on an output of a medium detector.

An first aspect of one or more embodiments may be an inkjet image formation apparatus that may include: a head drive processor that controls a recording head to eject an ink; a conveyance processor that controls a conveyance member to convey a recording medium; a carriage drive processor that controls a carriage with the recording head to move in a main scanning direction; a medium detector movable in the main scanning direction and configured to detect the recording medium on a platen; and a medium detection processor that obtains an output of the medium detector that detects plural points on the recording medium, and identifies a type of the recording medium based on the obtained output of the medium detector at the plural points or variation of an value of the output of the medium detector. A second aspect of one or more embodiments may be an inkjet image formation apparatus including a processer that may execute a program that causes the processor to perform operations, wherein the operations includes: operation as a head drive processor drives a recording head to eject an ink; operation as a conveyance processor that drives a conveyance member to convey a recording medium; operation as a carriage drive processor that drives a carriage with the recording head to move in a main scanning direction; operation as a medium detection processor that obtains an output of a medium detector that detects plural points on the recording medium on a platen, and identify a type of the recording medium based on the output of the medium detector at the plural points or variation of an value of the output of the medium detector. A third aspect of one or more embodiments may be an inkjet image formation apparatus that may include: a platen; a recording head; a carriage supporting the recording head and movable in the main scanning direction; a medium detector attached to the carriage to be movable in the main scanning direction, and configured to detect the recording medium on the platen; and a controller that obtains an output of the medium detector that detects plural points on the recording medium on the platen, and identify a type of the recording medium based on the output of the medium detector at the plural points or variation of an value of the output of the medium detector. A fourth aspect of one or more embodiments may be an inkjet image formation apparatus that may include: a platen on which a recording medium can be placed; a medium detector opposed to the platen and configured to detect the recording medium; a recording head opposed to the platen and configured to print an image on the recording medium by ejecting an ink; and a controller that obtains an output of the medium detector at plural points on the recording medium on the platen while one of the medium and the medium detector is moved with respect to the other, and changes a print setting based on the output of the medium detector at the plural points or variation of an value of the output of the medium detector.

According to at least one of the above aspects, the output of the medium detector at plural points on the recording medium is obtained, and a type of the recording medium is identified based on the output of the medium detector obtained at the plural points or variation of an value of the output of the medium detector.

Accordingly, the type of the recording medium can be appropriately identified even when the recording medium is a retroreflective medium.

### BRIEF DESCRIPTION OF DRAWINGS

FIG. 1 is a control block diagram illustrating a view of an inkjet printer according to one or more embodiments.

FIG. 2 is a diagram illustrating a perspective view of the inkjet printer according to one or more embodiments.

FIG. 3 is a diagram illustrating a conceptual view of a part of the inkjet printer according to one or more embodiments.

FIG. 4 is a diagram illustrating a conceptual view of a part of the inkjet printer according to one or more embodiments.

FIG. 5 is a diagram illustrating a conceptual view of a retroreflective medium according to one or more embodiments.

FIG. 6 is a diagram illustrating a view for explaining an operation of a medium detection processing part that determines whether a recording medium is a retroreflective medium according to one or more embodiments.

FIG. 7 is a diagram illustrating a flow chart of an operation of the inkjet printer according to one or more embodiments.

FIG. 8 is a diagram illustrating a flow chart of a subroutine of a first print process according to one or more embodiments.

FIG. 9 a diagram illustrating a flow chart of a subroutine of a second print process according to one or more embodiments.

### DETAILED DESCRIPTION

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

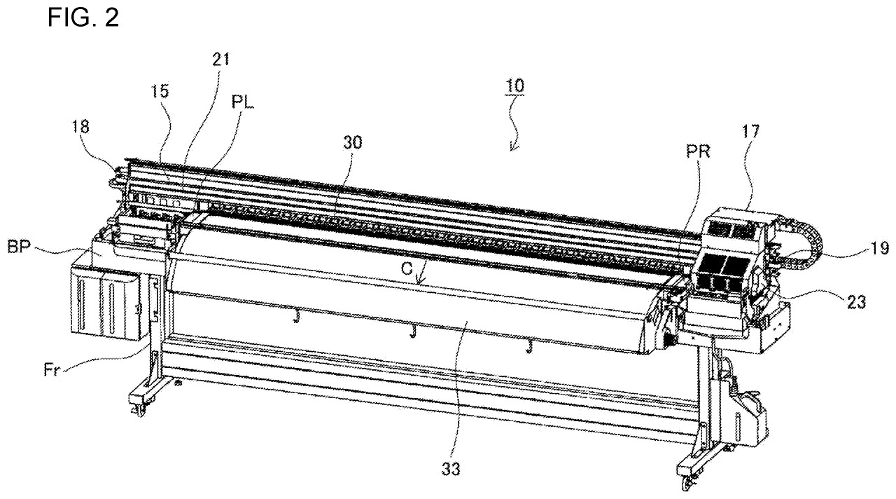

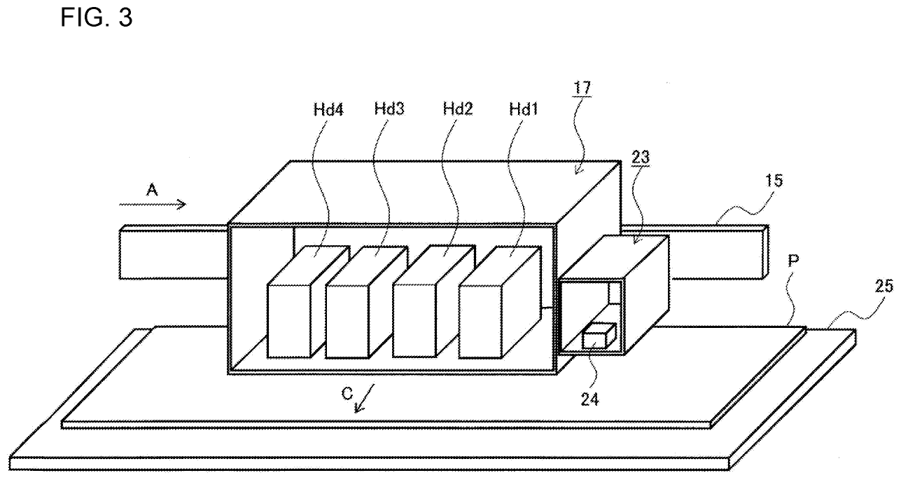

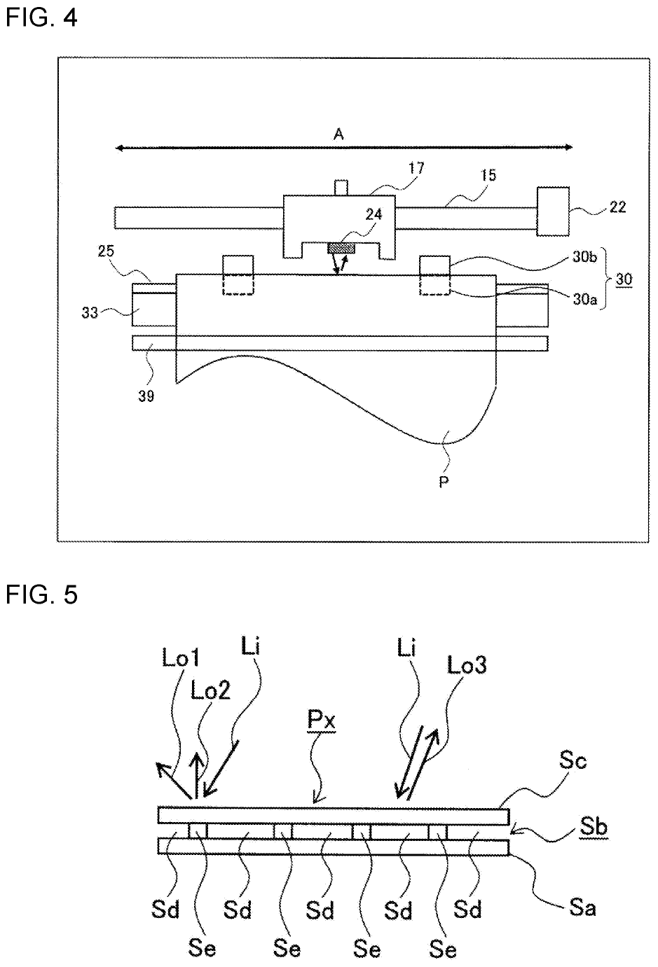

In the following descriptions, an inkjet printer is explained as an image formation apparatus. FIG. 2 is a diagram illustrating a perspective view of the inkjet printer according to one or more embodiments. FIG. 3 is a diagram illustrating a conceptual view of a part of the inkjet printer according to one or more embodiments. FIG. 4 is a diagram illustrating a conceptual view of a part of the inkjet printer according to one or more embodiments. FIG. 5 is a diagram illustrating a conceptual view of a retroreflective medium according to one or more embodiments.

In the drawings, 10 designates the inkjet printer, Fr designates a main body of the inkjet printer 10, that is a frame of the apparatus body. The frame Fr includes a base plate BP, a frame member PL serving as a first support member, and a frame member PR serving as a second support member. As seen from a front side of the inkjet printer 10 (that is, in a view of FIG. 2), the base plate BP extends from a left end to a right end of the main body, the frame member PL is projected upwardly from the base plate at a position away from the left end of the based plate BP by a predetermined distance, and the frame member PR is projected from the based plate BP at a position away from the right end of the based plated by a predetermined distance.

A rail 15 linearly extends and is provided (bridges) between the left and right ends of the base plate BP. A carriage 17 is provided to be movable along the rail 15 in the left-right direction, that is, in a main scanning direction (the direction of the arrow A). On the carriage 17, plural, (e.g., four in an embodiment) recording heads Hdi (i=1, 2, . . . , 4) are mounted such that each of the recording heads Hdi includes a nozzle surface (a surface of the recording head that includes openings of nozzles) facing in a downward direction. In an embodiment, ink drops of black, yellow, magenta and cyan are ejected from the nozzles of respective recording heads Hdi, so as to form a color image (multi-color image) on the recording medium.

A driving side pulley 18 is rotatably provided in the vicinity of a left end of the rail 15, and a driven side pully 19 is rotatably provided in the vicinity of a right end of the rail 15. An endless belt 21 is provided between and stretched by the pulleys 18 and 19 in such a way as to be capable of being conveyed by the pulleys 18 and 19. The carriage is attached to a predetermined position of the endless belt 21. A carriage motor 22, serving as a drive unit or a driver for moving the carriage, is connected to the pully 19.

Accordingly, by activating the carriage motor 22 to move the endless belt 21, the carriage 17 having the recording heads Hdi thereon is moved along the main scanning direction. At the same time, the color inks are ejected from the nozzles of the respective recording heads Hdi, while the recording medium P is conveyed in a direction vertical to the moving direction of the carriage 17, that is, a sub-scanning direction or a vertical scanning direction (the direction of the arrow C). With this, the color inks ejected from the respective recording heads Hdi are attached to the recording medium P, so as to from (print) a color image of letters, pictures, and/or the like on the recording medium P. Note that a paper sheet, a film of resin such as chloroethylene, PET, or the like, a retroreflective medium Px, or the like may be used as the recording medium P.

A sensor unit 23 is mounted on a right side (a side of the home position) of the carriage 17. In the sensor unit 23, an optical sensor 24 is provided. Accordingly, the optical sensor 24 is movable in the main scanning direction, along with movements of the carriage 17 in the main scanning direction.

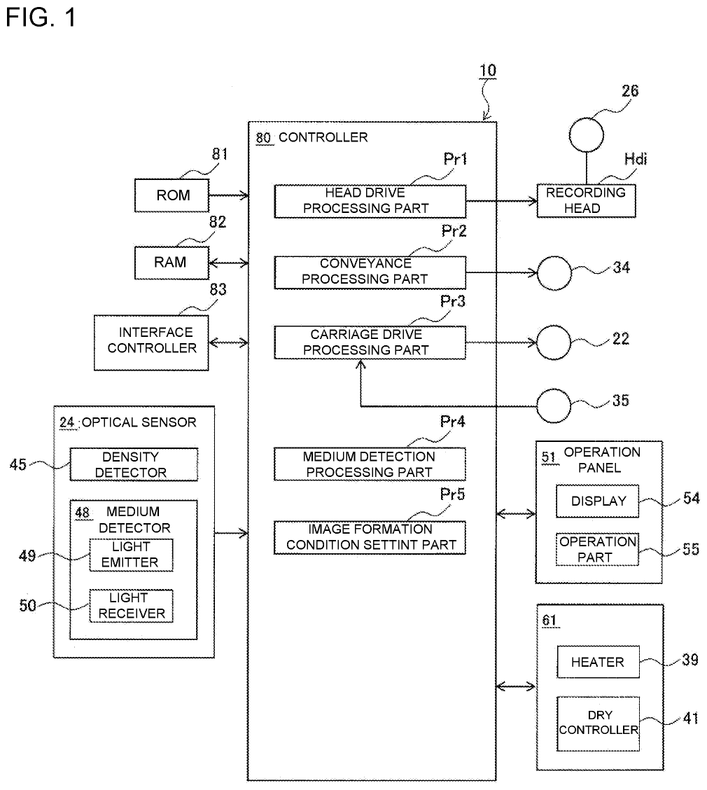

A linear scale (not illustrated) is provided linearly extending along and parallel to the rail 15 in such a manner that a scale of the linear scale can be optically read by a encoder 35 (see FIG. 1) mounted on the carriage 17, to detect a position of the carriage 17 based on a sensor output of the encoder 35. Thus, based on a change of the position of the carriage 17 in relation with the time, a movement speed of the carriage 17 can be calculated.

A platen 25, made of metal and having a plate shape, is provided linearly extending along and parallel to the rail 15. The platen 25 is provide on the base plate between the frame members PL and PR, in such a manner that the platen 25 supports thereon the recording medium P being conveyed on the platen 25.

On a rear side of the platen 25, an upstream guide (not illustrated) serving as a first medium guide is provided. The upstream guide is provided on an upstream side of the platen 25 in a medium conveyance direction and is configured to guide to the platen 25 the recording medium P drawn from a feed roll (not illustrated). Between the upstream guide and the platen 25 in the medium conveyance direction, conveying roller pairs 30 serving as conveyance members are rotatably provided.

The conveying roller pair 30 includes conveying rollers 30a serving as first rollers extending in the main scanning direction of the inkjet printer 10 and rotatably provided in the vicinity of the platen 25 and pinch rollers 30b serving as second rollers rotatably provided above the conveying rollers 30a at plural positions and pressed against the conveying roller 30a. When a conveyance motor 34 serving as a drive unit or a driver for conveying the medium is activated to rotate the conveying rollers 30a, the pinch rollers 30b are driven to rotate by the rotations of the conveying rollers 30a.

With this, the recording medium P is conveyed, with being pinched between the conveying rollers 30a and pinch rollers 30b along the upstream guide, to be fed onto the platen 25. Then, when the recording medium P is conveyed to a position opposed to the nozzle surfaces of the recording heads Hdi, the inks of the respective colors are ejected from the nozzles and attached onto the recording medium P, to form (print) an image on the recording medium P.

On a front side of the platen 25, a downstream guide 33 serving as a second guide is provided to guide the printed recording medium P to be discharged. The downstream guide is formed in a bent shape to downwardly guide the recording medium P discharged horizontally from the platen 25.

Accordingly, the recording medium P is drawn from the feed roll, guided by the upstream guide to the platen 25, printed on the platen 25 with the inks ejected from the nozzles of the recording heads Hdi to the recording medium P, guided by the downstream guide 33, and then taken up by a winding device (not illustrated). Note that a medium conveyance path is defined along the upstream guide, the platen 25, and the downstream guide 33.

Incidentally, the printed recording medium P has the inks attached thereto. Thus, if the printed recording medium P is discharged from the inkjet printer 10 and taken up by the winding device before the inks is dried, the recording medium P would get dirty by the undried ink.

In an embodiment, in order to dry the inks attached on the recording medium P to fix the ink to the recording medium P, the inkjet printer 10 includes a heater (not illustrated) serving as a first heater provided to the platen 25, a heater (not illustrated) serving as a second heater provided upstream of the platen 25 and on a back side of (below) the upstream guide, and a heater (not illustrated) serving as a third heater provided downstream of the platen 25 and on a backside of (below) the downstream guide 33. Each of the heaters is covered with and surrounded by an aluminum sheet. Accordingly, the recording medium P, which is conveyed through the upstream guide, the platen 25, and the downstream guide 33, is heated by the heaters, and thus the inks attached to the recording medium P can be sufficiently dried.

By the way, it is preferable that traffic signs on roads or the like has a good noticeability to be recognized by a driver or the like, when a headlight of a vehicle as a light source is turned on to emit light. Accordingly, a retroreflective medium Px such as illustrated in FIG. 5 may be used as a recording medium, on which an image is printed, to be used for an irradiated member such as a traffic sign or the like.

The retroreflective medium Px includes, for example, a base layer Sa, an intermediate layer Sb on the base layer Sa, and a film layer Sc (or a surface layer) on the intermediate layer Sb, such that an image of a traffic sign is able to be printed on the film layer Sc.

The intermediate layer Sb includes: a reflective layer Sd including a prismatic layer containing a plurality of prisms and an air layer surrounding the prisms; and a support layer Se (bonding agent layer) as a frame part for the reflective layer Sd having a predetermined shape to dividing the reflective layer into plural sections and maintain a thickness of the reflective layer Sd.

The light Li that is incident on the prisms in the prismatic layer in the reflective layer Sd, is refracted in the prisms to return in the direction opposite to the incident direction.

When the light Li from the headlight of the vehicle is irradiated to the retroreflective medium Px, the light Li passes through the film layer Sc to the intermediate layer Sb and is reflected on the intermediate layer Sb, so that the reflected lights Lo1 to Lo3 are emitted through the film layer Sc.

At this time, a specular reflection or a diffuse reflection occurs on the support layer Se of the intermediate layer Sb, in a way same as or similar to the a normal recording medium such as a paper sheet, a resin film, or the like, while the retroreflective reflection occurs on the reflective layer Sd of the retroreflective medium due to the refraction in the prisms. Thus, the reflected lights Lo1 and Lo2 by the specular reflection or the diffuse reflection on the support layer Se are radiated through the film layer Sc in directions, while the reflected light Lo3 by the retroreflective reflection on the reflective layer Sd is returned through the film layer Sc to the vehicle in a direction.

Thus, the reflected light Lo3 returned to the vehicle can be noticeably recognized by the driver of the vehicle, due to the retroreflective medium Px of the traffic sign.

However, when an image such as a traffic sign is to be printed on the retroreflective medium Px, at least one of image forming conditions (setting) such as a condition (setting) for driving the recording heads Hdi, a condition (setting) for conveying the recording medium P, a condition (setting) for drying the inks attached on the recording medium P, or other conditions is different from that when an image is to be printed on a normal recording medium.

In an embodiment, the inkjet printer 10 detects the recording medium P by the optical sensor 24 and determines a type of the recording medium p, that is, determines whether the recording medium P is the retroreflective medium Px or not, and changes the image forming conditions (settings) when it is determined that the recording medium P is the retroreflective medium Px. For example, when it is determined that the recording medium P is the retroreflective medium Px, the inkjet printer 10 changes (increases) a total amount of heat to heat the recording medium P for drying the inks attached on the recording medium P, as one of the image forming conditions (the printing conditions).

In an embodiment, in addition to the first to third heaters, a heater 39 such as an infrared heater or the like serving as a fourth heater is provided for increasing a total value of outputs of the heaters for heating the recording medium P. The heater 39 (fourth heater) is provided downstream of the platen 25 in the medium conveyance direction, more specifically, downstream of the downstream guide 33 (that is, downstream of the third heater). The heater 39 faces a front surface (or an upper surface) of the recording medium P on which the inks are attached and extends, in the width direction of the recording medium P, from one to the other of the widthwise ends of the recording medium P. Accordingly, the heater 39 can directly heat, with its radiation heat, the inks attached to the recording medium P from the side of the surface (front surface) on which the inks are attached. For example, when it is determined that the recording medium P is a medium other than a retroreflective medium Px, the inkjet printer 10 heats the conveyed recording medium P by the second heater provided under (on the back side of) the upstream guide, the first heater under (on the back side of) the platen, and the third heater under (on the back side of) the downstream guide, to dry the inks attached to the recording medium P. On the other hand, when it is determined that the recording medium P is a retroreflective medium Px, the inkjet printer 10 heats the conveyed recording medium P by the fourth heater in addition to the first to the third heaters, to dry the inks attached to the conveyed recording medium P.

Next, a controller of the inkjet printer 10 is explained.

FIG. 1 illustrates a view of a control block diagram of the inkjet printer according to one or more embodiments.

In the figure, 10 designates the inkjet printer, 24 designates the optical sensor, 51 designates an operation panel, 61 designates an outside drier, 80 designates a controller that controls the sequence in the entire of the inkjet printer 10 to control printing or the like, 81 designates a non-volatile memory such as a ROM serving as a first storage unit, 82 designates a volatile memory such as a RAM serving as a second storage unit, 83 designates an interface controller that receives print data from an external apparatus or an information process apparatus such as a host computer (not illustrated) and stores the print data to the RAM 82. In an embodiment, the printer 10 receives the print data through a USB cable or the like, however, may receive through a wireless LAN or the like.

The optical sensor 24 includes a density detector 45. The density detector 45 includes a light emitter (not illustrated) such as a LED or the like, and a light receiver or light detector (not illustrated) such as a phototransistor or the like. The density detector 45 emits a light generated by the light emitter to the recording medium P, and receives, by the light receiver, the light reflected by the recording medium P, to detect a density (a contrast) of the image of each color.

The optical sensor 24 also includes a medium detector 48. The medium detector 48 includes a light emitter 49 such as a LED or the like, and a light receiver 50 or a light detector such as a phototransistor or the like. The medium detector 48 emits a light generated by the light emitter 49 to the recording medium P, and receives, by the light receiver 50, the light reflected by the recording medium P, to detect the recording medium P.

In an embodiment, the medium detector 48 is moved in the main scanning direction along with movements of the carriage 17 (see FIG. 3), and the light emitter 49 of the medium detector 48 emits light to the recording medium P stopped on the platen at predetermined regular sampling intervals, and the light receiver 50 receives the light reflected by the recording medium P, to generate a sensor output.

That is, the medium detector 48 detects plural points on the recording medium P along the main scanning direction to generate the sensor output by the light receiver 50. For example, in an embodiment, the medium detector 48 detects the recording medium P at the predetermined regular sampling intervals within a range between about 0.001 mm to 1 mm inclusive along the main scanning direction, to generate the sensor output.

The operation panel 51 includes a display 54 such as a LED display or the like to display a status of the inkjet printer 10 and an operation part 55 or an input part including a switch(es) and a key(s) through which an operator or a user inputs an instruction to the inkjet printer 10. Note that in a case where the operation panel 51 is composed of a touch panel, the touch panel may function as an operation part as well a display.

The outside drier 61 includes the heater 39 provided outside of the guides to face the recording medium P, and a dry controller 41 configured to control the entire of the outside drier 61 and turn on and off the heater 39 by controlling a power distribution to the heater 39.

The controller 80 includes a CPU serving as an arithmetic device or a processor, an input/output port, a timer, and the like and executes various processes based on programs stored in the ROM 81. The ROM 81 stores therein: as well as the programs, various initial setting values; first to fourth threshold values Vth1 to Vth4 used for determining whether the recording medium P is a normal recording medium or a retroreflective medium Px; one or more first voltage waveforms of the sensor output which is to be obtained in a case where the recording medium P is a normal recording medium, one or more second voltage waveforms of the sensor output which is to be obtained in a case where the recording medium P is a retroreflective medium Px; and the like. The RAM 82 temporarily stores therein an image data to execute printing generated based on the print data, and various data for controlling.

The RAM 82 functions as a work area in which the CPU executes computing.

The controller 80 includes a head drive processing part Pr1 or a head drive processor, a conveyance processing part Pr2 or a conveyance processer, a carriage drive processing part Pr3 or a carriage drive processor, a medium detection processing part Pr4 or a medium detection processor, an image formation condition setting part Pr5 or an image formation condition setting processor, and the like.

The head drive processing part Pr1 reads out the print data from the RAM 82, converts the print data to generate an image data, transmits the generated image data to the recording heads Hdi, and drives the recording heads Hdi to form (print) an image based on the generated image data on the recording medium P.

Note that each of the recording heads Hdi includes a piezo element 26 serving as a driving element for each nozzle. When a voltage is applied between electrodes (not illustrated) provided at both ends of the piezo element 26, the piezo element 26 is driven to expand or contract in response to the applied voltage to deform a side wall of an ink path in which the ink is flowed to the nozzle in the recording head Hdi, so as to change the cross-part area of the ink path, to eject a drop of the ink by an amount of the change of the cross-section area of the ink path.

The conveyance processing part Pr2 transmits a drive signal to the conveyance motor 34 to drive the conveyance motor 34, so as to rotate the conveying roller pairs 30 (see FIG. 2), which conveys the recording medium P in the direction of the arrow C (the sub-scanning direction).

The carriage drive processing part Pr3 performs a PWM control to drive the carriage motor 22, so as to rotate (move) the endless belt 21, which can reciprocate the carriage 17 in the direction of the arrow A (the main scanning direction). Accordingly, the carriage drive processing part Pr3 reads out from the ROM 81 a target position and a target speed of the carriage 17, receives the output of the encoder 35, performs an analog-digital conversion of the output to detect the position of the carriage 17, generates a PWM control signal as a control value, and transmits the PWM control signal to the carriage motor 22. The carriage motor 22 receives the PWM control signal, changes the rotational speed thereof in proportion to a duty ratio of the PWM control signal, so as to move the carriage 17 to the target position at the target speed while accelerating and decelerating the moving speed thereof. Then, the carriage drive processing part Pr3 transmits the position of the carriage 17 to the head drive processing part Pr1, and the head drive processing part Pr1 ejects the ink drops from the nozzles of each recording head Hdi at the timing calculated based on the position of the carriage 17 and the image data.

The medium detection processing part Pr4 obtains the sensor output (for example, the output voltage) of the light receiver 50 of the medium detector 48 before executing printing on the recording medium P, and identifies a type of the recording medium P based on the obtained sensor output, that is, determines whether the recording medium P is a retroreflective medium Px or not.

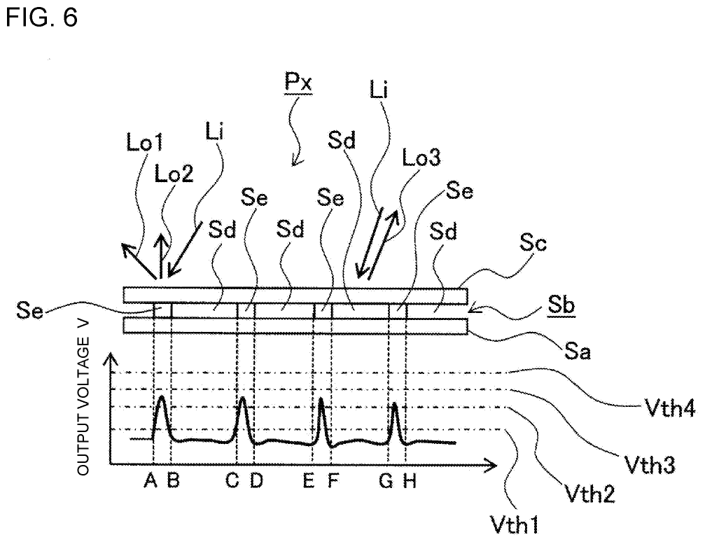

Specifically, the medium detection processing part Pr4 calculates, based on the output voltage V (see FIG. 6) of the sensor output of the light receiver 50 and the first to fourth threshold value Vth1 to Vth4, a voltage waveform of the output voltage V, and identifies, based on the voltage waveform of the output voltage V, a type of the recording medium P.

The image formation condition setting part Pr5 sets an image formation setting such that an image formation setting for a retroreflective medium Px is different from an image formation setting for a normal recording medium. For example, the image formation condition setting part Pr5 sets, when the recording medium P is a normal recording medium, an image formation setting in which the heater 39 is not activated not to heat the recording medium P and sets, when the recording medium P is a retroreflective medium Px, an image formation setting in which the heater 39 is activated to heat the recording medium P.

Next, an operation of the medium detection processing part Pr4 to determine whether the recording medium P is a retroreflective medium Px or not is explained.

FIG. 6 is a diagram illustrating a view for explaining the operation of the medium detection processing part that determines whether the recording medium is a retroreflective medium according to one or more embodiments. Note that in FIG. 6, the horizontal axis represents a position on the retroreflective medium Px at which the light emitter 49 (see FIG. 1) emits the light, and the vertical axis represents the output voltage V of the sensor output of the light receiver 50.

As illustrated in the Figure, the retroreflective medium Px includes, for example, the base layer Sa, the intermediate layer Sb on the base layer Sa, and the film layer Sc (surface layer) on the intermediate layer Sb, such that an image is to be printed on the film layer Sc.

The intermediate layer Sb includes: the reflective layer Sd including the prismatic layer containing the plurality of prisms and the air layer surrounding the prisms; and the support layer Se (bonding agent layer) functioning as the frame part for the reflective layer Sd having the predetermined shape to divide the reflective layer Sd into plural sections or define the reflective layer Sd and to maintain the thickness of the reflective layer Sd.

The light Li that is incident on the prisms in the prismatic layer in the reflective layer Sd is refracted in the prisms to be returned in the direction opposite to the incident direction.

Accordingly, when the light Li is irradiated from the light emitter 49 to the retroreflective medium Px as the recording medium, the light Li passes through the film layer Sc to the intermediate layer Sb, reflected by the intermediate layer Sb, so that the reflected lights Lo1 to Lo3 are returned through the film layer Sc.

At this time, a specular reflection or a diffuse reflection occurs on the support layer Se of the intermediate layer Sb, in a way same as or similar to a normal recording medium, while the retroreflective reflection occurs on the reflective layer Sd of the retroreflective medium due to the refraction in the prisms. Thus, the reflected light Lo1 by the specular reflection and the reflected light Lo2 by the diffuse reflection on the support layer Se are radiated through the film layer Sc in directions, while the reflected light Lo3 by the retroreflective reflection on the reflective layer Sd is returned through the film layer Sc to the light emitter 49.

The light emitter 49 and the light receiver 50 of the optical sensor 24 are arranged to be adjacent to each other in the main scanning direction. Thus, when the light emitter 49 and the light receiver 50 are located above the support layer Se and the light emitter 49 emits the light Li, the reflected light Lo1 goes to the light receiver 50. However, when the light emitter 49 and the light receiver 50 are located at a position other than above the support layer Se and the light emitter 49 emits the light Li, the reflected light Lo3 is returned to the light emitter 49 and does not go to the light receiver 50.

FIG. 6 illustrates a relationship between the output voltage V of the light receiver 50 of the optical sensor 24 and the position of the optical sensor 24 with respect to the retroreflective medium Px that has the support layer Se formed in the areas A-B, C-D, E-F, and G-H of the retroreflective medium Px. As illustrated in FIG. 6, while the optical sensor 24 is passing above the area A-B, the area C-D, the area E-F, and the area G-H of the retroreflective medium Px, the output voltage V of the light receiver 50 is high. While the optical sensor 24 is passing above the reflective layer Sd of the retroreflective medium Px, the output voltage V of the light receiver 50 is low.

In the FIG. 6, Vth1 designates a first threshold to determine whether the light emitter 49 and the light receiver 50 are located above the reflective layer Sd of the retroreflective medium Px or not. Thus, when the output voltage V1 is lower than the first threshold Vth1, it can be determined that the light emitter 49 and the light receiver 50 are moving above the reflective layer Sd of the retroreflective medium Px.

Vth2 and Vth3 designate a second threshold and a third threshold to determine whether the light emitter 49 and the light receiver 50 are located above the support layer Se of the retroreflective medium Px. Thus, when the output voltage V is not less than the second threshold Vth2 and less than the third threshold Vth3, it can be determined that the light emitter 49 and the light receiver 50 are moving above the support layer Se of the retroreflective medium Px.

Vth4 designates a fourth threshold to determine whether the light emitter 49 and the light receiver 50 is located above a normal recording medium. Thus, when the output voltage V is not less than the fourth threshold Vth4, it can be determined that the light emitter 49 and the light receiver 50 are moving above the normal recording medium.

Accordingly, the medium detection processing part Pr4 reads out from the ROM 81 the first to fourth threshold value Vth1 to Vth4, and determines whether the output voltage V is within a first range which is not greater than the first threshold Vth1, or whether the output voltage V is within a second range not less than the second threshold Vth2 and less than the third threshold Vth3. When the value of the output voltage V is varied (shifted) to the first range and the second range alternatingly (periodically) to have a voltage waveform, it is assumed that the recording medium P is the retroreflective medium Px.

Specifically, the medium detection processing part Pr4 calculates cycles (or intervals) in which the output voltage V gets in the second range, calculates a voltage waveform of the output voltage V based on the calculated cycles, determines whether the calculated voltage waveform of the output voltage V matches one of the one or more voltage waveforms stored in the ROM 81, and then determines that the recording medium P is a retroreflective medium Px when the calculated voltage waveform of the output voltage V matches one of the one or more voltage waveforms stored in the ROM

The medium detection processing part Pr4 determines that the recording medium P is a normal recording medium, when the output voltage V is maintained in the third range not less than the fourth threshold Vth4.

Next, an operation of the inkjet printer 10 is explained.

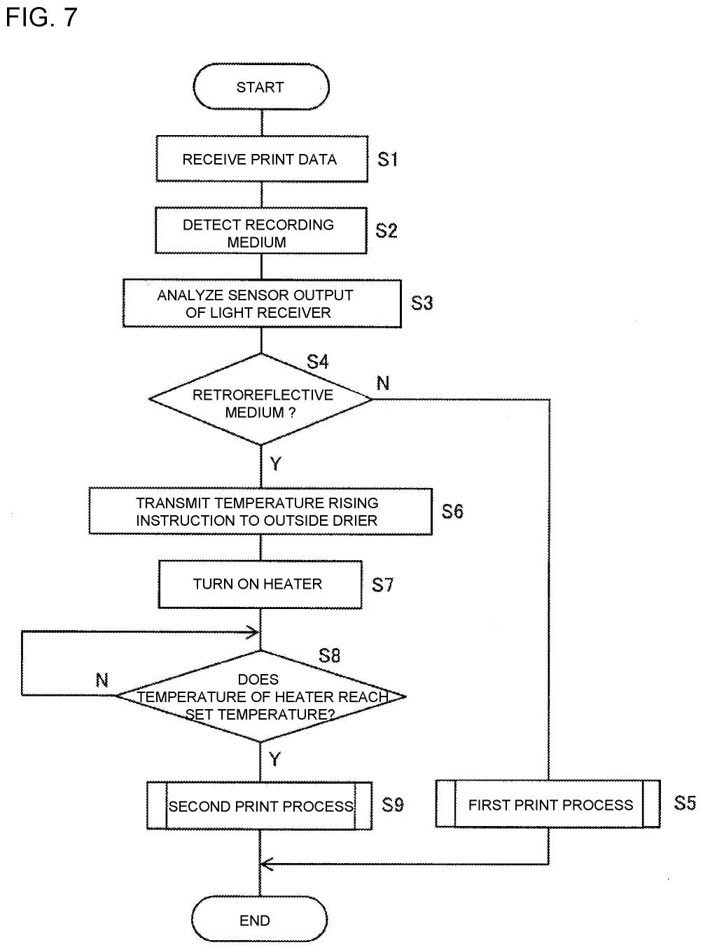

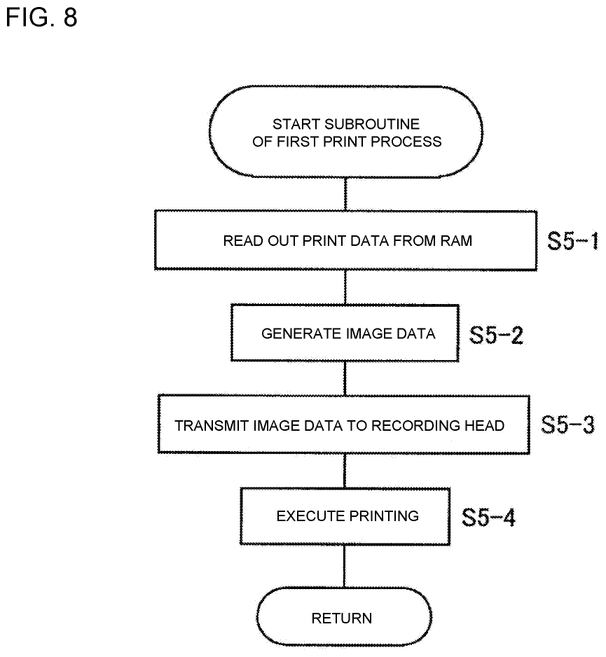

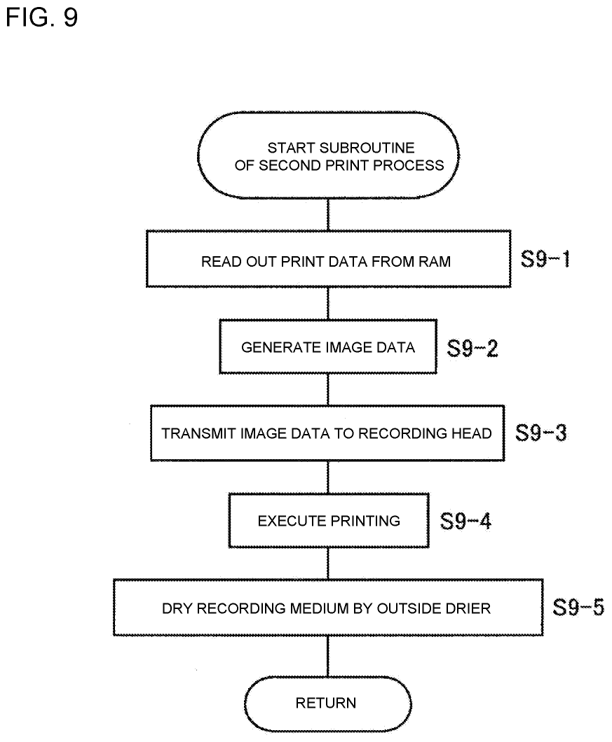

FIG. 7 is a diagram illustrating a flow chart of an operation of the inkjet printer according to one or more embodiments. FIG. 8 is a diagram illustrating a flow chart of a subroutine of a first print process and FIG. 9 a diagram illustrating a flow chart of a subroutine of a second print process according to one or more embodiments.

First, the interface controller 83 receives the print data from the host computer and saves the print date in the RAM 82.

Next, the carriage drive processing part Pr3 moves the carriage 17 along the main scanning direction to move the optical sensor 24 above the recording medium P stopped on the platen 25 from one end to the other end of the recording medium P along the main scanning direction.

While moving the optical sensor 24 above the recording medium P, the medium detection processing part Pr4 instructs the medium detector 48 to detect the recording medium P.

Thus, the light emitter 49 of the medium detector 48 emits light to the recording medium P, and the light receiver 50 of the medium detector 48 receives light reflected from the recording medium P, to detect the recording medium P.

Then, the medium detection processing part Pr4 reads and analyzes the sensor output (for example, the output voltage) of the light receiver 50.

At this time, the medium detection processing part Pr4 calculates a voltage waveform of the output voltage V of the sensor output. That is, the medium detection processing part Pr4 determines, based on the first to third thresholds Vth1 to Vth3, whether the output voltage V is within the first range not greater than the first threshold Vth1 less than, and whether the output voltage V is within the second range not less than the second threshold Vth2 and less than the third threshold Vth3, and assumes that the recording medium P is a retroreflective medium Px when the output voltage V is varied to the first range and the second range alternatingly.

Then, the medium detection processing part Pr4 reads the positions of the carriage 17 calculated based on the sensor output of the encoder 35 in relation to the time, and calculates cycles at which the output voltage V gets in the second range, and calculates a voltage waveform of the output voltage V based on the calculated cycles.

The medium detection processing part Pr4 also determines whether the output voltage V is maintained within the fourth range not less than the fourth threshold Vth4, and calculates a voltage waveform of the output voltage V, when the output voltage V is maintained within the fourth range.

Next, the medium detection processing part Pr4 compares the calculated voltage waveform of the output voltage V with the voltage waveforms stored in the ROM 81, and determines whether the calculated voltage waveform of the output voltage V matches one of the stored one or more voltage waveforms for the retroreflective medium Px and whether the calculated voltage waveform of the output voltage V matches one of the stored one or more voltage waveforms for the normal medium.

Then, the medium detection processing part Pr4 determines that the recording medium P is the retroreflective medium Px when the calculated voltage waveform of the output voltage V matches one of the stored one or more voltage waveforms for the retroreflective medium Px and determines that the recording medium P is the normal medium when the calculated voltage waveform of the output voltage V matches one of the stored one or more voltage waveforms for the normal medium.

When it is determined that the recording medium P is not the retroreflective medium Px but is the normal recording medium, the controller 80 executes a first print process.

In the first print process, the controller 80 reads out from the RAM 82 the print data, converts the print data to generate the image data. The controller 80 then transmits the image data to the recording heads Hdi, to execute printing.

For executing printing, the carriage drive processing part Pr3 moves the carriage 17 in the main scanning direction, and the conveyance processing part Pr2 conveys the recording medium P, and the head drive processing part Pr1 drives the recording heads Hdi to eject the inks, so as to form (print) an image with the inks on the recording medium P. Then, the conveyance processing part Pr2 further conveys the printed recording medium P to complete the second print process.

On the other hand, when it is determined that the recording medium P is the retroreflective medium Px, the image formation condition setting part Pr5 transmits to the outside drier 61 an instruction to rise the temperature. When receiving the temperature rising instruction, the dry controller 41 of the outside drier 61 turns on the heater 39, and waits until the temperature of the heater 39 reaches a set temperature.

When the temperature of the heater 39 reaches the set temperature, the dry controller 41 transmits to the controller 80 a notification of the completion to rise the temperature, and the controller 80 then executes a second print process, when receiving the completion notification.

In the second print process, the controller 80 reads out from the RAM 82 the print data, converts the print data to generate the image data. The controller 80 then transmits the image data to the recording heads Hdi, to execute printing.

For executing printing, the carriage drive processing part Pr3 moves the carriage 17 in the main scanning direction, and the conveyance processing part Pr2 conveys the recording medium P, and the head drive processing part Pr1 drives the recording heads Hdi to eject the inks, so as to form (print) an image with the inks on the recording medium P.

Then, the conveyance processing part Pr2 further conveys the printed recording medium P, to further dry the inks attached on the recording medium P by the outside drier 61. Note that in the second print process, the conveyance processing part Pr2 conveys the printed recording medium in a speed same as that in the first print process.

With this, even when the recording medium P is the retroreflective medium Px, the recording medium P can be sufficiently dried. Note that when the recording medium P is the normal recording medium, the recording medium P is not dried by the outside drier 61, so that the recording medium P would not be excessively dried.

Next, a flow chart illustrated in FIG. 7 is explained.

Step S1: The interface controller 83 receives the print data from the host computer.

Step S2: The medium detector 48 detects the recording medium P while the carriage drive processing part Pr3 moves the carriage 17 in the main scanning direction.

Step S3: The medium detection processing part Pr4 analyzes the sensor output of the light receiver 50.

Step S4: The medium detection processing part Pr4 determines whether the recording medium P is the retroreflective medium Px or not. Note that in step S4, it may detect or determine the width of the recording medium P. When it is determined that the recording medium P is the retroreflective medium Px, the process proceeds to step S6, while it is determined that the recording medium P is the normal recording medium, the process proceeds to step S5.

Step S5: The controller 80 executes the first print process, and then ends the process.

Step S6: The image formation condition setting part Pr5 transmits to the outside drier 61 the temperature rising instruction.

Step S7: The dry controller 41 turns on the heater 39 of the outside drier 61.

Step S8: The dry controller 41 waits until the temperature of the heater 39 reaches the set temperature. When the temperature of the heater 39 reaches the set temperature, the process proceeds to step S9.

Step S9: The controller 80 executes the second print process, and then ends the process.

Next, a subroutine illustrated in FIG. 8 is explained.

Step S5-1: The controller 80 reads out from the RAM 82 the print data.

Step S5-2: The controller 80 generates the image data.

Step S5-3: The controller 80 transmits the image data to the recording heads Hdi.

Step S5-4: The controller 80 executes the printing and then returns the process.

Next, a subroutine illustrated in FIG. 9 is explained.

Step S9-1: The controller 80 reads out from the RAM 82 the print data.

Step S9-2: The controller 80 generates the image data.

Step S9-3: The controller 80 transmits the image data to the recording heads Hdi.

Step S9-4: The controller 80 executes the printing.

Step S9-5: The outside drier 61 dries the recording medium, and then returns the process.

According to one or more embodiments described above, the light receiver 50 of the medium detector 48 is moved in the main scanning direction above the recording medium stopped on the platen 25, to detect plural points of the recording medium P to generates the sensor output, and the medium detection processing part Pr4 identifies, based on the sensor output at plural points (that is, variation of the value of the sensor output), the type of the recording medium P.

Accordingly, even if the recording medium P is the retroreflective medium Px, the type of the recording medium P can be appropriately identified. When it is determined that the recording medium P is a medium other than the retroreflective medium Px, the inkjet printer 10 heats the recording medium P being conveyed as a normal recording medium, by the first to third heaters, to dry the inks attached on the recording medium P. On the other hand, when it is determined that the recording medium P is the retroreflective medium Px, the inkjet printer 10 heats the recording medium P being conveyed, by the fourth heater in addition to the first to third heaters, to dry the inks attached on the recording medium P. Therefore, the inkjet printer can sufficiently dry the inks attached on the recording medium P, even when the recording medium P is the retroreflective medium Px.

In one or more embodiments described above, the reflective layer Sd of the retroreflective medium Px includes the prismatic layer as a refractive layer, however an embodiment or a modification is not limited to this. For example, an embodiment or a modification, the reflective layer Sd may include a bead layer including beads as a refractive layer.

In one or more embodiments described above, the inkjet printer 10 determines whether the recording medium P is the retroreflective medium or not after receiving the print data. However, an embodiment or a modification is not limited to this. For example, an embodiment or a modification may determines whether the recording medium P is the retroreflective medium or not, after the recording medium is set (loaded) to the printer and before the print data is received.

In one or more embodiments described above, the inkjet printer 10 includes the carriage 17 with the recording heads Hdi movable above the platen 25 in the main scanning direction, and prints the image on the recording medium by moving the carriage 17 in the main scanning direction while ejecting the inks from the recording heads Hdi on the recording medium P stopped on the platen. However, an embodiment or a modification is not limited to this. For example, an embodiment or a modification may be applied to a structure that has no carriage and in which one or more print heads is not movable with respect to a platen, and ejects inks to the recording medium while the recording medium is being moved on the platen. In one or more embodiments described above, the conveyance processing part Pr2 conveys, in the second print process, the printed recording medium at the speed same as that in the first print process. However, an embodiment or a modification is not limited to this. For example, an embodiment or a modification, the conveyance processing part may convey, in the second print process, the printed recording medium in a speed slower or faster than that in the first print process, and may temporarily stop the printed recording medium at a position opposed to the outside drier 61.

In one or more embodiments described above, the inkjet printer 10 is described, however, an embodiment or a modification is not limited to this. For example, an embodiment or a modification may be applied to an image formation apparatus such as a copier, a facsimile, a multi-function printer or peripheral (“MFP”), or the like, and may be applied to an image reading apparatus such as a scanner or the like.

The invention includes other embodiments or modifications in addition to the above-described embodiments and modifications without departing from the spirit of the invention. The embodiments and modifications are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. An inkjet image formation apparatus comprising:
a head drive processor that drives a recording head to eject an ink;
a conveyance processor that drives a conveyance member to convey a recording medium;
a carriage drive processor that drives a carriage with the recording head to move in a main scanning direction;
a medium detector movable in the main scanning direction and configured to detect the recording medium on a platen; and
a medium detection processor that obtains an output of the medium detector that detects plural points on the recording medium, and identifies a type of the recording medium based on the obtained output of the medium detector at the plural points.

2. The inkjet image formation apparatus according to claim 1, wherein
the medium detection processor identifies the type of the recording medium based on an output voltage of the medium detector as the obtained output and one or more thresholds.

3. The inkjet image formation apparatus according to claim 2, wherein
the one or more thresholds comprises a first threshold, a second threshold greater than the first threshold, a third threshold greater than the second threshold, and
the medium detection processor identifies the type of the recording medium, based on whether the output voltage is within a first range not greater than the first threshold, and whether the output voltage is within a second range not less than the second threshold and less than the third threshold.

4. The inkjet image formation apparatus according to claim 3, wherein
the medium detection processor calculates cycles in which the output voltage gets in the second range, and identifies the type of the recording medium based on the calculated cycles.

5. The inkjet image formation apparatus according to claim 4, wherein
the medium detection processor calculates a voltage waveform based on the calculated cycles and identifies the type of the recording medium based on whether the calculated voltage waveform matches one of one or more voltage waveforms stored in a storage.

6. The inkjet image formation apparatus according to claim 3, wherein
the recording medium comprises a retroreflective medium that includes: a reflective layer including a refractive layer and an air layer; and a support layer defining the reflective layer, and
the output voltage gets in the first range when the medium detector detects the reflective layer of the retroreflective medium and gets in the second range when the medium detector detects the support layer of the retroreflective medium.

7. The inkjet image formation apparatus according to claim 3, wherein
the medium detection processor determines that the recording medium is a retroreflective medium, when the output voltage gets in the second range periodically.

8. The inkjet image formation apparatus according to claim 3, wherein
the medium detection processor determines that the recording medium is a retroreflective medium, when cycles in which the output voltage gets in the second range match predetermined cycles.

9. The inkjet image formation apparatus according to claim 1, wherein
the medium detector comprises a light emitter and a light receiver, wherein the light receiver receives light emitted by the light emitter and reflected by the recording medium, to generate the output of the medium detector.

10. An inkjet image formation apparatus comprising:
a platen;
a recording head;
a carriage supporting the recording head and movable in a main scanning direction;
a medium detector attached to the carriage to be movable in the main scanning direction, and configured to detect a recording medium on the platen; and
a controller that obtains an output of the medium detector that detects plural points on the recording medium on the platen, and identifies a type of the recording medium based on the output of the medium detector at the plural points.

11. An inkjet image formation apparatus comprising:
a platen on which a recording medium can be placed;
a medium detector opposed to the platen and configured to detect the recording medium;
a recording head opposed to the platen and configured to print an image on the recording medium by ejecting ink; and
a controller that obtains an output of the medium detector that detects plural points on the recording medium on the platen while one of the recording medium and the medium detector is moved with respect to the other, and changes a print setting based on the output of the medium detector at the plural points.

12. The inkjet image formation apparatus according to claim 11, further comprising
a carriage having the recording head and the medium detector attached thereto and movable in a main scanning direction, wherein
the controller obtains the output of the medium detector at the plural points while moving the carriage with the medium detector in the main scanning direction with the recording medium being stopped, and changes the print setting based on the output of the medium detector at the plural points.

13. The inkjet image formation apparatus according to claim 12, wherein
the controller that obtains the output of the medium detector at the plural points at regular intervals along the main scanning direction.

14. The inkjet image formation apparatus according to claim 13, wherein
the regular intervals are within a range between 0.001 mm to 1.0 mm inclusive.

15. The inkjet image formation apparatus according to claim 11, wherein
the controller changes the print setting by increasing a total output power of one or more heaters, when the output of the medium detector gets in a first range and a second range alternatingly, wherein the first range is not greater than a first threshold voltage, and the second range is between a second threshold voltage and a third threshold voltage inclusive, wherein the second threshold voltage is greater than the first threshold voltage and the third threshold voltage is greater than the second threshold voltage.

16. The inkjet image formation apparatus according to claim 15, wherein
the one or more heaters comprises one or more first heaters provided on a back side of a medium conveyance path and a second heater provided on a front side of the medium conveyance path and downstream of the platen.

17. The inkjet image formation apparatus according to claim 16, wherein
the controller changes the print setting by turning on the second heater in addition to the one or more first heaters, when the output of the medium detector gets in the second range periodically.
